(19) United States
(12) Patent Application Publication
(10) Pub. No.: US 2019/0351766 A1
(43) Pub. Date: Nov. 21, 2019

(54) COLOR CHANGING NEEDLE FOR VEHICLE GAUGE

(71) Applicant: Paul Spivak, Eastlake, OH (US)

(72) Inventor: Paul Spivak, Eastlake, OH (US)

(21) Appl. No.: 15/983,298

(22) Filed: May 18, 2018

(51) Int. Cl. B60K 35/00; G01D 13/26; B60Q 3/16; B60Q 3/64

(52) U.S. Cl. CPC B60K 35/00; G01D 13/265; B60K 2350/2008; B60Q 3/64; B60K 2350/1064; B60Q 3/16

(57) ABSTRACT

Disclosed embodiments provide a programmable gauge suited for vehicular applications. A multicolored lighting element illuminates a gauge needle in response to an input value. Thus, the needle can be a first color under certain conditions, and then transition to a second color under different conditions. In embodiments, the programmable gauge can serve as a tachometer, speedometer, fuel level gauge, oil pressure gauge, temperature gauge, altimeter, and/or other gauge types.

### FIELD OF THE INVENTION

The present invention relates generally to instrumentation, and more particularly, to programmable vehicle gauges.

### BACKGROUND

Vehicle gauges are an essential tool for safe and compliant operation of motor vehicles such as cars, trucks, boats, and airplanes. For land vehicles such as cars and trucks, gauges such as the speedometer, tachometer, and fuel level gauge are relied upon frequently by a driver to ensure proper operating conditions.

A speedometer is a gauge that measures the current speed of a vehicle. With modern electronic speedometers, a rotation sensor, often coupled to the transmission, provides a series of electronic pulses whose frequency corresponds to the rotational speed of the drivetrain. The sensor is typically a toothed metal disk located between a coil and a magnetic field sensor. As the disk turns, the teeth pass between the two, each time producing a pulse in the sensor as they affect the strength of the magnetic field it is measuring. A computer converts the pulses to a speed and displays this speed on an electronically-controlled, analog-style needle.

A tachometer is an instrument that measures the rotational speed of the motor's crankshaft. The tachometer displays the revolutions per minute (RPM) on a calibrated analog dial. The tachometer is an important gauge, providing driver assistance in determining optimal shifting points, and maximum engine RPM, known as the “red line,” beyond which, serious engine damage could occur.

The fuel level gauge is used to monitor the amount of fuel in the tank, to prevent the driver from running out of fuel. In many cases running the tank dry can cause problems, such as being stranded. The aforementioned gauges, along with others, are important components of a vehicle instrument cluster.

### SUMMARY

In one embodiment, there is provided a programmable gauge, comprising a processor; a memory coupled to the processor; a needle; a needle motion controller; a multicolored light element configured and disposed to illuminate the needle; wherein the memory contains instructions, that when executed by the processor, cause the gauge to receive an input value, and configure the needle motion controller and multicolored light element in response to the received input value.

In another embodiment, there is provided a computer-implemented method for programming a gauge, comprising: obtaining a plurality of vehicle parameters; obtaining user settings, wherein the user settings comprise a plurality of colors and corresponding input value ranges loading the plurality of vehicle parameters into the gauge; and loading the user settings into the gauge.

### BRIEF DESCRIPTION OF THE DRAWINGS

The structure, operation, and advantages of the present invention will become further apparent upon consideration of the following description taken in conjunction with the accompanying figures (FIGs.). The figures are intended to be illustrative, not limiting.

Certain elements in some of the figures may be omitted, or illustrated not-to-scale, for illustrative clarity. The cross-sectional views may be in the form of “slices”, or “near-sighted” cross-sectional views, omitting certain background lines which would otherwise be visible in a “true” cross-sectional view, for illustrative clarity. Furthermore, for clarity, some reference numbers may be omitted in certain drawings.

FIG. 1 is a block diagram of a programmable gauge in accordance with embodiments of the present invention.

FIG. 2 shows details of a multicolor needle illumination system in accordance with embodiments of the present invention.

FIG. 3A shows additional details of a multicolor needle illumination system in accordance with embodiments of the present invention.

FIG. 3B shows additional details of a multicolor needle illumination system in accordance with additional embodiments of the present invention.

FIG. 4A shows a tachometer in accordance with embodiments of the present invention in a normal range.

FIG. 4B shows a tachometer in accordance with embodiments of the present invention in a caution range.

FIG. 4C shows a tachometer in accordance with embodiments of the present invention in a warning range.

FIG. 5 shows a system diagram for configuring a programmable gauge in accordance with embodiments of the present invention.

FIG. 6 shows an exemplary user interface for gauge configuration in accordance with embodiments of the present invention.

FIG. 7 shows an additional exemplary user interface for gauge configuration in accordance with embodiments of the present invention.

FIG. 8 shows an instrument cluster of programmable gauges in accordance with embodiments of the present invention.

FIG. 9 is a flowchart indicating process steps for embodiments of the present invention.

FIG. 10 is a flowchart indicating process steps for additional embodiments of the present invention.

FIG. 11A shows a speedometer with an input value in a first range.

FIG. 11B shows a speedometer with an input value in a second range for a predetermined duration.

FIG. 12 is a flowchart indicating process steps for additional embodiments of the present invention.

FIG. 13 shows an alternative embodiment of a programmable gauge in accordance with embodiments of the present invention.

FIG. 14 is a flowchart indicating process steps for configuring the programmable gauge of FIG. 13.

### DETAILED DESCRIPTION

Disclosed embodiments provide a programmable gauge suited for vehicular applications. A multicolored lighting element illuminates a gauge needle in response to an input value. Thus, the needle can be a first color under certain conditions, and then transition to a second color under different conditions. In embodiments, the programmable gauge can serve as a tachometer, speedometer, fuel level gauge, oil pressure gauge, temperature gauge, altimeter, and/or other gauge types.

One application for such gauges is in aftermarket automotive applications. Automotive enthusiasts often upgrade original equipment and/or accessorize their vehicle with new equipment to increase performance and/or create a customized appearance for their vehicles.

In embodiments, an electronic computing device such as a smartphone, tablet computer, laptop computer, desktop computer, or other suitable electronic computing device interfaces with the programmable gauge to configure it for a particular vehicle and desired operation. As an example, a user installing a programmable tachometer gauge can use the electronic computing device to enter vehicle information, such as number of cylinders in the engine of the vehicle. Additionally, the user can enter/edit configuration information such as at which input values (e.g. RPM values) the needle color is to change, and to which colors. As an example, a user may configure a programmable tachometer in accordance with embodiments of the present invention such that the gauge needle is illuminated white for RPM values below 4,000 RPM, illuminated yellow for RPM values from 4,000 RPM to 5,000 RPM, and red for values above 5,000 RPM. In this way, the illuminated needle can convey additional information to the user, enhancing the user experience when operating the vehicle. These, and other embodiments are further detailed in the following description.

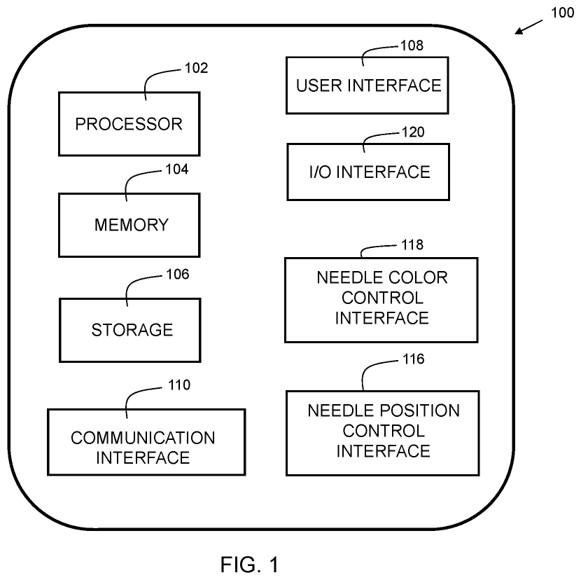

FIG. 1 is a block diagram of a programmable gauge 100 in accordance with embodiments of the present invention. Gauge 100 includes a processor 102, which is coupled to a memory 104. Memory 104 may include dynamic random-access memory (DRAM), static random-access memory (SRAM), magnetic storage, and/or a read only memory such as flash, EEPROM, optical storage, or other suitable memory. In some embodiments, the memory 104 may be a non-transitory computer readable medium. Memory 104 stores instructions, which when executed by the processor, implement functionality of the present invention.

Gauge 100 may further include storage 106. In embodiments, storage 106 may include one or more magnetic storage devices such as hard disk drives (HDDs). Storage 106 may additionally include one or more solid state drives (SSDs). In some embodiments, the storage 106 may be used to store vehicle parameters such as number of cylinders, engine RPM limits, and/or maximum vehicle speed attained values.

Gauge 100 may further include a user interface 108. This may be a display, such as an LED display, a touch-sensitive screen, one or more buttons, switches, or any other suitable interface for a user to interface with gauge 100. In embodiments, the buttons may be used to cycle through various modes, such as for selecting a tachometer mode for 4, 5, 6, 8, and 12-cylinder engines.

The communication interface 110 may include a dedicated interface for receiving automotive input data such as a CAN bus interface, and/or an OBD-II interface. In some embodiments, the communication interface 110 comprises a wireless communication interface. In embodiments, the wireless communication interface includes a BluetoothTM interface. In some embodiments, the communication interface 110 may alternatively/additionally include a wired communication interface, such as a USB interface. Other suitable communication protocols may be supported by the communication interface 110.

Gauge 100 further includes a needle position control interface 116. In embodiments, the needle position control interface 116 may include a stepper motor, motor with a rotary encoder, or other suitable mechanism to move a gauge needle to a desired orientation on a gauge, to reflect an input value received from the communication interface.

Gauge 100 further includes a needle color control interface 118. The needle color control interface may include circuitry and/or devices for providing a needle illumination color. In some embodiments, the needle color control interface can include a multicolor light-emitting diode (LED). The multicolor light-emitting diode may provide red, green, and blue LEDs that can be controlled by pulse code modulation (PCM), waveform duty cycle, or other suitable mechanism. In this way, the intensity of each LED can be controlled individually, allowing for a wide variety of colors that can be produced.

Gauge 100 may further include an input/output (I/O) interface 120. The I/O interface may be configured to interact directly with sensor circuitry for direct reading of sensors to obtain input values. The input values pertain to the parameter being measured by the gauge. For example, for a tachometer, the input values can be engine speed values.

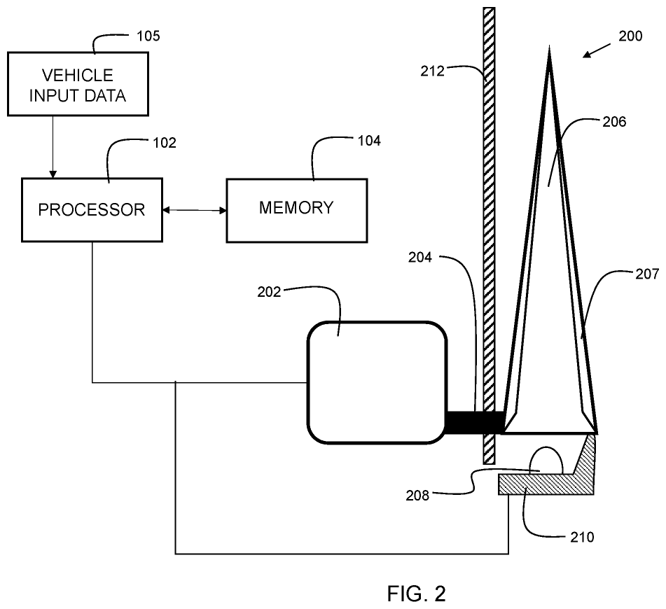

FIG. 2 shows details of a multicolor needle illumination system 200 in accordance with embodiments of the present invention. Processor 102 executes instructions stored in memory 104 to carry out steps in accordance with embodiments of the present invention. Processor 102 receives periodic vehicle input data 105 from sensors through the I/O interface 120, a data bus (e.g. CAN bus), or other suitable source. Based on the value of the input data, the processor 102 controls stepper motor 202. Stepper motor 202 includes a shaft 204. A gauge needle 206 is affixed to the distal end of the shaft 204. Thus, in this embodiment, stepper motor 202 serves as a needle motion controller. A multicolored light element 208 is affixed to a bracket 210 disposed at the base of the gauge needle 206. The gauge needle 206 may be hollow with a translucent surface 207 such that, when illuminated from the base by multicolored light element 208, the color from the multicolored light element 208 is projected onto the surface 207 of the needle 206, causing the needle color as viewed by the user to change. A backplate 212 is disposed behind the needle 206 with respect to a user. The backplate 212 typically includes appropriate indicia for the gauge type, such as markings for a tachometer, speedometer, fuel level indicator, or the like.

In embodiments, the memory further contains instructions, that when executed by the processor, receive a first range corresponding to a first needle illumination color, and a second range corresponding to a second needle illumination color.

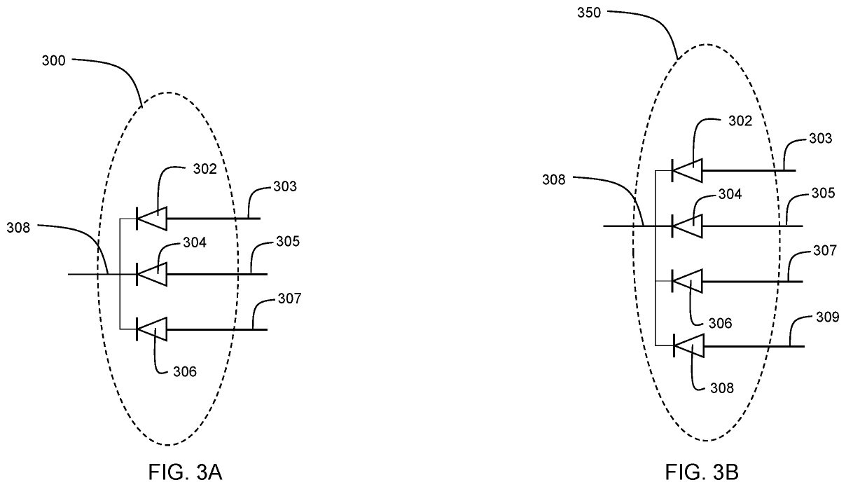

FIG. 3A shows additional details of a multicolor needle illumination system 300 in accordance with embodiments of the present invention. A system such as system 300 may be used as element 208 in FIG. 2 in some embodiments. In embodiments, the multicolor needle illumination system 300 includes three light-emitting diodes, indicated as 302, 304, and 306. In embodiments, LED 302 comprises a red LED, LED 304 comprises a green LED, and LED 306 comprises a blue LED. LED 302 has anode 303, LED 304 has anode 305, and LED 306 has anode 307. The cathodes of the LEDs 302, 304, and 306 are connected to form a common cathode 308. Other LED colors and configurations are possible in some embodiments. Thus, in embodiments, the multicolored light element comprises a multicolor light-emitting diode.

FIG. 3B shows additional details of a multicolor needle illumination system 350 in accordance with additional embodiments of the present invention. The multicolor needle illumination system 350 is similar to the multicolor needle illumination system 300 of FIG. 3A, but further includes a fourth LED 308, having anode 309. LED 308 may be a white LED. While it is possible to create a white light from the primary colors of LED 302, LED 304, and LED 306. It can be advantageous to have a dedicated white LED for improved brightness and/or switching times.

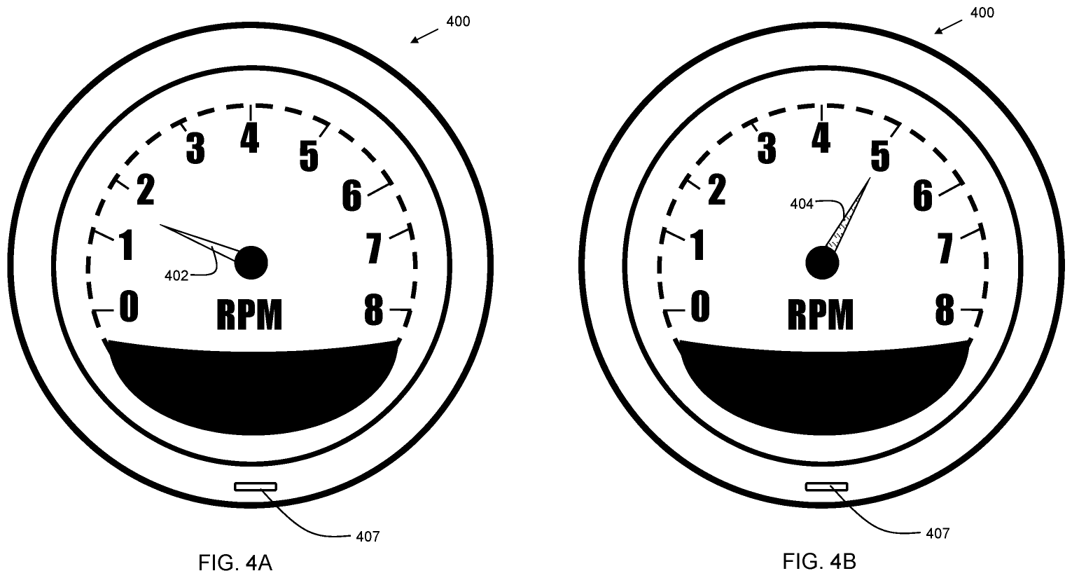

FIG. 4A shows a tachometer 400 in accordance with embodiments of the present invention in a normal range. Thus, in embodiments, the programmable gauge is a tachometer, and the input value is an engine speed value. Tachometer 400 shows indicia for measuring RPM (revolutions per minute) of an engine. A needle 402 points to the approximate instantaneous RPM value. As shown in FIG. 4A, needle 402 is illuminated with a first color (e.g. white) and indicates an RPM value of about 1,600 RPM. A communications port 407 may be used to connect the tachometer 400 to a computer, tablet computer, smartphone, or other suitable device in order to configure the tachometer for the engine type, as well as establish user preferences. In some embodiments, the communications port 407 may include a mini USB connector, micro USB connector, USB type C connector, or other suitable connector. FIG. 4B shows the tachometer 400 in accordance with embodiments of the present invention in a caution range. FIG. 4B includes needle 404 illuminated with a second color (e.g. yellow) and indicates an RPM value of about 5,000 RPM. The yellow color can serve as a caution indication that the engine is approaching the recommended limit (e.g. “red line”). FIG. 4C shows the tachometer 400 in accordance with embodiments of the present invention in a warning range. FIG. 4C includes needle 406 illuminated with a third color (e.g. red) and indicates an RPM value of about 6,800 RPM. The red color can serve as a caution indication that the engine has exceeded the recommended limit (e.g. “red line”). Thus, in embodiments, the memory further contains instructions, that when executed by the processor, receive a third range corresponding to a third needle illumination color.

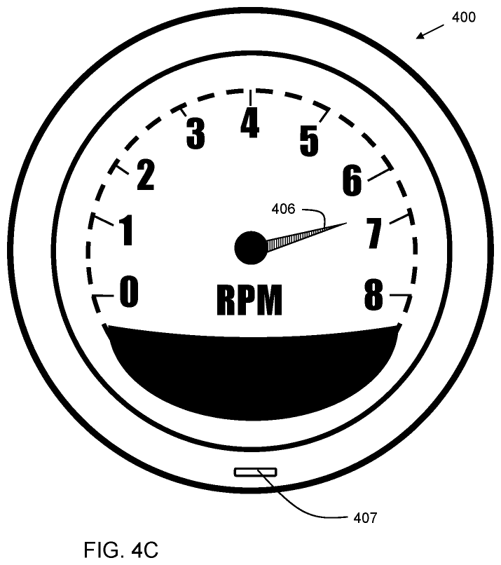

FIG. 5 shows a system 500 for configuring a programmable gauge in accordance with embodiments of the present invention. A gauge programming server 502 is a computer comprising a processor 540, memory 542, and storage 544.

Memory 542 includes instructions, which when executed by processor 540, causes server 502 to implement elements of embodiments of the present invention. Server 502 is connected to network 522. Network 522 may be the Internet, a wide area network, a local area network, or any other suitable network. Client 524 is an electronic computing device connected to the network 522. Client 524 may be a smartphone, tablet computer, laptop computer, or any other suitable device with communication capabilities. Client 524 is coupled to programmable gauge 526 via communication link 528. In embodiments, communication link 528 may be a wireless communication link such as a Bluetooth™ communication link. In other embodiments, communication link 528 may be a wireless communication link such as a USB communication link.

During configuration, a user enters various information into a user interface of an application executing on client 524. The information can include a vehicle type (make, model, year, etc.). In embodiments, the vehicle type information is sent to the gauge programming server 502 via network 522. In embodiments, the transfer of vehicle type information from the client 524 to the server 502 may utilize protocols including, but not limited to, TCP/IP, UDP, JSON, XML, and/or HTML. Upon receiving the vehicle type information, the gauge programming server 502 may retrieve additional information for that vehicle from vehicle database 556. When a user specifies a given vehicle type in the user interface of the client 524, the gauge programming server may retrieve information from the vehicle database 556 indicating the number of cylinders, and default limits and corresponding needle colors. As an example, upon entering a vehicle type of “1992 Honda Prelude” the corresponding entry in the vehicle database 556 may contain an engine type of “4-cylinder,” and default information such as a normal range of 0-4,999 RPM, a normal needle color of white, a caution range of 5,000-6,399 RPM, a caution needle color of yellow, a warning range of 6,400 or higher RPM, and a warning needle color of red. In some embodiments, the default settings may be overridden by the user to allow customization. For example, a user may wish to change the ranges, so that they can receive the warning color at a lower RPM level. Additionally, the user may wish to change the default needle color from white to blue to match his/her design preferences. These and other options may be changed through the user interface of the application executing on client 524.

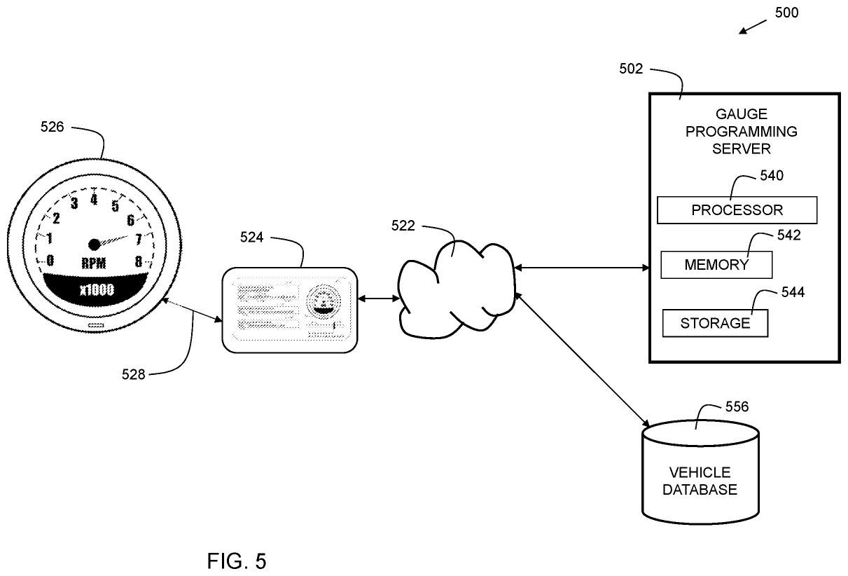

FIG. 6 shows an exemplary user interface 600 for gauge configuration in accordance with embodiments of the present invention. In field 602, a user can select a vehicle type. In embodiments, this may include a dropdown list for manufacturers and models, or other suitable mechanism. An engine type field 604 may then be automatically populated based on the vehicle type from the vehicle database 556. In some embodiments, more than one engine type may be retrieved (e.g. if a vehicle is offered with both a 4-cylinder and a 6-cylinder engine option). In such embodiments, there may be a dropdown list or other suitable user interface mechanism to allow the user to select the desired engine. In some embodiments, the user may override the choices with any desired cylinder value. This can be useful in cases where a user installs an engine type that was not offered as part of the original equipment. As an example, if a user has installed an 8-cylinder engine into a vehicle that was only offered with a 6-cylinder engine, the user can override the 6-cylinder setting. In some implementations, the cylinder setting is an important parameter for a tachometer to properly indicate the engine speed (RPM). A plurality of ascending range fields, indicated as 622 (normal), 624 (caution), and 626 (warning) are shown. Range field 622 corresponds to a normal range during ascending input values. Range field 624 corresponds to a caution range during ascending input values. Range field 626 corresponds to a warning range during ascending input values. Each range can comprise multiple fields. Fields may include, but are not limited to, a start field, an end field, a transition field, and a color field. The start field indicates a starting input value for the color indicated in the color field. The end field indicates an ending input value for the color indicated in the color field. The transition field indicates an offset from the start field value for transitioning to the specified color. The color field indicates the color for the gauge needle when the input values are within the range defined by the start field value and the end field value.

Similarly, a plurality of descending range fields, indicated as 632 (normal), 634 (caution), and 636 (warning) are shown. The transition field indicates an offset from the end field value for transitioning to the specified color. Range field 632 corresponds to a normal range during descending input values. Range field 634 corresponds to a caution range during descending input values. Range field 636 corresponds to a warning range during descending input values. In some cases, the ascending range values and descending range field values for a given range may be identical.

Referring now to the specific data in the ascending and descending range fields, the ascending normal range field 622 includes a start input value of zero. In the case of a tachometer, the start input value corresponds to zero RPM. The ascending normal range field 622 includes an end input value of 4000, a transition of 0, and color of white. This configures the programmable gauge to set a needle illumination color of white as the input value goes from 0 RPM to 4,000 RPM.

The ascending caution range field 624 includes a start input value of 4,001, an end input value of 6000, a transition of 500, and color of yellow. This configures the programmable gauge to set a needle illumination color of yellow as the input value goes from 4,001 RPM to 6,000 RPM. The transition value of 500 configures the programmable gauge to gradually transition the needle color from the previous color (white) to yellow over an increase of 500 RPM. Thus, at an input value of 4001 RPM, the needle color is gradually changed from white to yellow by configuring the multicolored light element accordingly as a function of input value such that, after a transition of 500, to 4501 RPM, the needle color is set to yellow. In embodiments this can be accomplished by starting with the red, green, and blue LEDs at full intensity to create a white light, and then gradually reducing the blue component of the multicolored light element to create a yellow light for the gauge needle, thereby providing a yellow gauge needle color.

The ascending warning range field 626 includes a start input value of 6,001, an end input value of UNL (unlimited), a transition of 0, and color of red. This configures the programmable gauge to set a needle illumination color of red as the input value exceeds 6,000 RPM. The transition value of 0 configures the programmable gauge to instantly transition the needle color from the previous color (yellow) to red upon the input value reaching 6,001 RPM. In embodiments this can be accomplished by reducing the blue component and green component of the multicolored light element to create a red light for the gauge needle, thereby providing a red gauge needle color.

Similarly, the descending normal range field 632 includes a start value of zero and an end input value of 4,500, a transition of 0, and color of white. The descending caution range field 634 includes a start input value of 4,501, an end input value of 7,000, a transition of 500, and color of yellow. This configures the programmable gauge to set a needle illumination color of yellow as the input value decreases from 7,000 RPM to 4501 RPM. The transition value of 500 configures the programmable gauge to gradually transition the needle color from the previous color (red) to yellow over a decrease of 500 RPM. Thus, at an input value of 7,000 RPM, the needle color is gradually changed from red to yellow by configuring the multicolored light element accordingly as a function of input value such that, after a transition of 500, to 6,500 RPM, the needle color is set to yellow. In embodiments this can be accomplished by starting with the red LED at full intensity to create a red light, and then gradually increasing the green component of the multicolored light element to create a yellow light for the gauge needle, thereby providing a yellow gauge needle color.

The ascending warning range field 636 includes a start input value of 7,001, an end input value of UNL (unlimited), a transition of 0, and color of red. This configures the programmable gauge to maintain a needle illumination color of red as the input value exceeds remains above 7,000 RPM.

Thus, with disclosed embodiments, the color setting for the gauge needle can vary depending on whether the input parameter is increasing or decreasing. For example, during increases in engine speed, the gauge needle is set to red when the engine speed exceeds 6,000 RPM. During decreases in engine speed, the needle transitions from red to yellow when the engine speed falls below 7,001 RPM. In this way, the needle color may change at different points depending on whether the input value is increasing or decreasing. For certain applications, such as drag racing, it can be useful to have different color change points for increasing and decreasing input values. In other embodiments, the ascending ranges and descending ranges for a gauge may be set to identical values, such that the normal, caution, and warning ranges are the same for both ascending and descending conditions.

User interface 600 may further include a virtual programmable gauge 606 rendered on the user interface. The virtual programmable gauge 606 includes a gauge needle 609. A user interface control such as a slide control 608 and slider 610 may be used to select an input value. As the user moves the slider 610, the position and color of gauge needle 609 is changed to reflect the input value and trend (increasing or decreasing) of the input value.

Thus, in embodiments, obtaining user settings comprises obtaining a normal range, a caution range, and a warning range. Embodiments may further include obtaining ascending limits and descending limits for at least one of the normal range, caution range, and warning range. Embodiments may further include rendering a simulated gauge that includes a needle rendered with a needle illumination color. In embodiments, the simulated gauge is a tachometer. In embodiments, the gauge includes memory that further contains instructions, that when executed by the processor, receive a first ascending range and a first descending range corresponding to a first needle illumination color, and a second ascending range and a second descending range corresponding to a second needle illumination color.

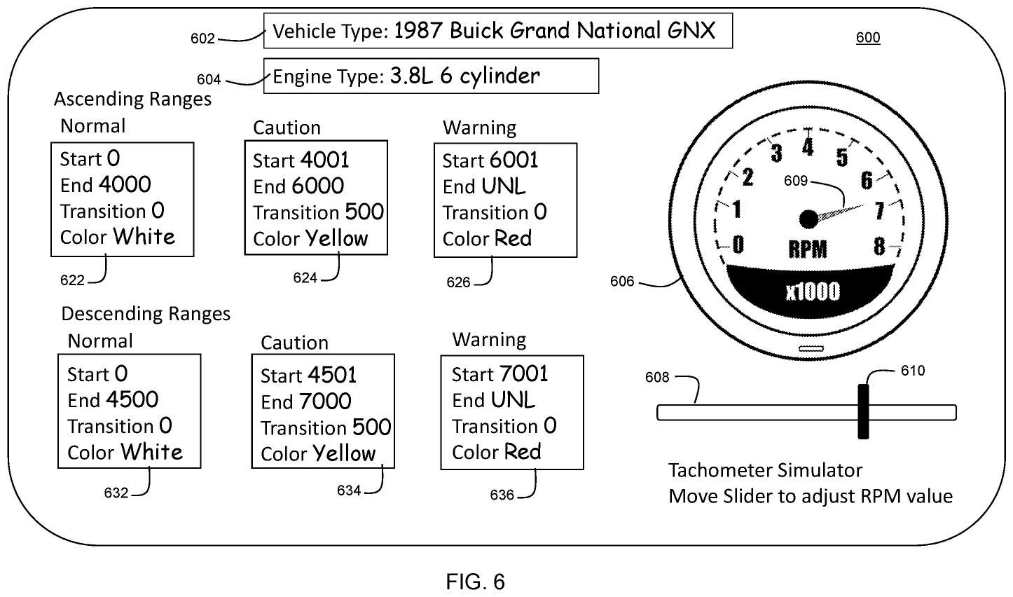

FIG. 7 shows an additional exemplary user interface 700 for gauge configuration in accordance with additional embodiments of the present invention. User interface 700 can be used for an instrument cluster including multiple programmable gauges in accordance with embodiments of the present invention. In embodiments, a plurality of programmable gauge rules is displayed. A first rule field 722 is presented for tachometer configuration. A second rule field 732 is presented for speedometer configuration. A third rule field 742 is presented for fuel level gauge configuration.

Rule field 722 includes parameter 724A and 724B for a selectable color below a particular RPM limit. As shown, parameter 724A is set to “white” and parameter 724B is set to “5,001.” This provides the behavior of setting a gauge needle illumination color to white when the RPM is below 5,001 RPM. Rule field 722 further includes parameter 726A for a selectable color above an RPM limit specified with parameter 726B. Additionally, a duration parameter 726C is provided for further control of the needle illumination color. As shown, parameter 726A is set to “red,” parameter 726B is set to “5,000,” and parameter 726C is set to “8.” This provides the behavior of setting a gauge needle illumination color to red when the RPM value exceeds 5,000 RPM for 8 seconds. Thus, with this configuration, a momentary spike above 5,000 RPM, that lasts less than 8 seconds, does not result in a change in the gauge needle illumination color.

Rule field 732 includes parameter 734A for a selectable default gauge needle illumination color and parameter 734B for a selectable gauge needle illumination color for the event of when a new maximum speed is reached. As shown, parameter 734A is set to “white” and parameter 734B is set to “blue.” In embodiments, a speedometer in accordance with disclosed embodiments stores the maximum speed in non-volatile storage (e.g. 106 of FIG. 1). If the current speed exceeds the previously stored maximum speed, the needle illumination color is set to the color specified by parameter 734B and the new maximum speed is stored in the non-volatile storage. As configured, the gauge needle is illuminated in white, unless a new maximum speed is achieved, in which case the needle is illuminated in blue. In embodiments, the needle may remain illuminated in blue until the next power-cycle of the gauge. That is, when the vehicle is shut off and then turned on again, the gauge needle illumination color may then revert to the default color (white in this example).

Rule field 742 includes parameter 744A for a selectable default gauge needle illumination color for the fuel level gauge needle, and parameter 744B for when a fuel level is below 25 percent of the fuel capacity. As shown, parameter 744A is set to “white” and parameter 734B is set to “blue.”

In embodiments, user interface 700 may further include a simulated gauge. In embodiments, the simulated gauge 706 is a speedometer. The simulated gauge 706 includes a gauge needle 709. A user interface control such as a slide control 708 and slider 710 may be used to select an input value. As the user moves the slider 710, the position and color of gauge needle 709 is changed to reflect the input value. In this case, the input value is a vehicle speed value. The user interface 700 is exemplary, and other fields may be included in some embodiments. Some embodiments may include more rules per gauge. Some embodiments may include multiple simulated gauges. In some embodiments the low fuel level threshold that causes a needle color change may be configurable. Other embodiments may include rules and/or simulated gauges for other gauge types, including, but not limited to, oil temperature, oil pressure, voltage gauge, amperage gauge, and/or turbo boost gauge. For each gauge, programmable ranges, and optionally durations, may be established to control the operation of the multicolor needle illumination system in accordance with embodiments of the present invention.

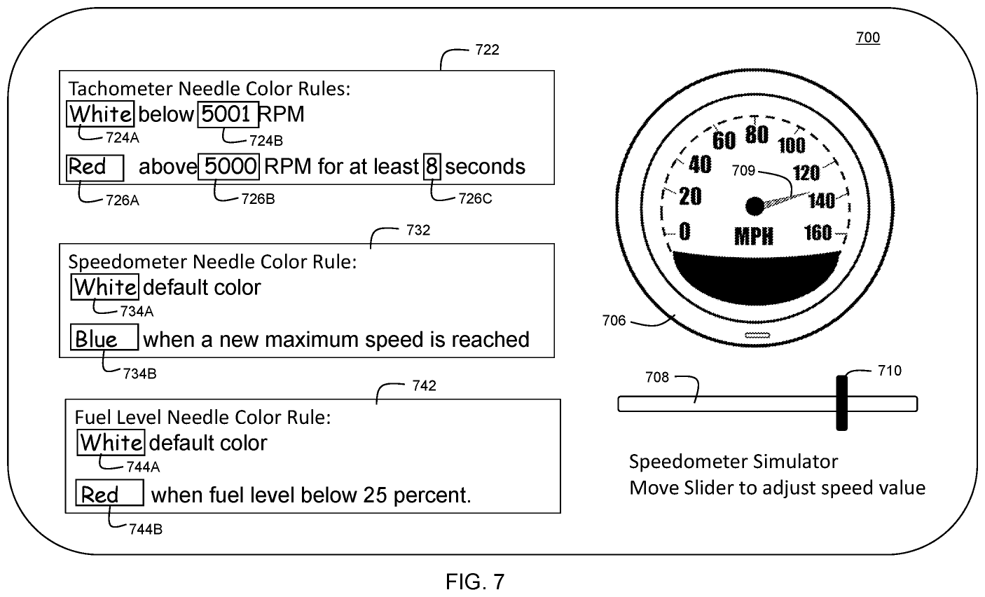

FIG. 8 shows an instrument cluster 800 of programmable gauges in accordance with embodiments of the present invention. Instrument cluster 800 includes a fuel level gauge 802. Fuel level gauge 802 comprises a gauge needle 804 that is configured to illuminate in a default color (e.g. white), and a second color (e.g. red) when the fuel level falls below a predetermined threshold (e.g. ¼ tank, or 25 percent). Thus, in embodiments, the memory further contains instructions, that when executed by the processor, configure the programmable gauge as a fuel gauge, and the input value is a fuel level value.

Instrument cluster 800 further includes a speedometer 812. Speedometer 812 comprises a gauge needle 814 that is configured to illuminate in a default color (e.g. white), and a second color (e.g. blue) when the speed exceeds a predetermined threshold (e.g. previous maximum speed, or a preset speed (e.g. 88 mph)). Thus, in embodiments, the memory further contains instructions, that when executed by the processor, configure the programmable gauge as a speedometer, and the input value is a vehicle speed value.

Instrument cluster 800 further includes a tachometer 822. Tachometer 822 comprises a gauge needle 824 that is configured to illuminate in a default color (e.g. white), and a second color (e.g. yellow) when the RPM reach a second range, and a third color (e.g. red) when the RPM reach a third range. Instrument cluster 800 is an example, and other embodiments may include other programmable gauges instead of, or in addition to the gauges shown in instrument cluster 800. These gauges may include, but are not limited to, oil temperature, oil pressure, voltage gauge, amperage gauge, and/or turbo boost gauge.

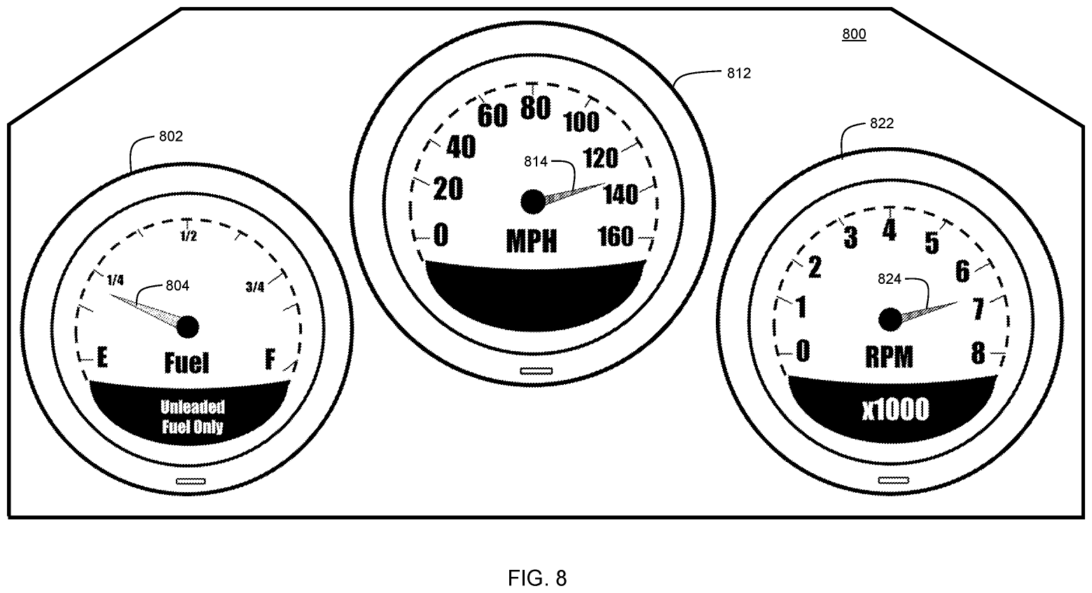

FIG. 9 is a flowchart 900 indicating process steps for embodiments of the present invention. At process step 950, vehicle parameters are obtained. These parameters can include, but are not limited to, number of engine cylinders, recommended engine RPM limits, recommended vehicle speed limits, and/or other relevant limits and ranges. In embodiments, these parameters may be obtained from a vehicle database via a computer network. In process step 952, parameters are loaded into the programmable gauge. These parameters may include parameters obtained in process step 950. In embodiments, the parameters are loaded into the programmable gauge from an electronic device connected to the programmable gauge via a communication link, as shown in FIG. 5. In embodiments, this may include a wired communication link such as a USB link, or a wireless communication link such as a BluetoothTM connection. In process step 954, user settings, such as color preferences and/or user overrides of default parameters, are loaded into the programmable gauge. In embodiments, the user settings are loaded into the programmable gauge from an electronic device connected to the programmable gauge via a communication link, as shown in FIG. 5. In embodiments, this may include a wired communication link such as a USB link, or a wireless communication link such as a Bluetooth™ connection.

In process step 956, an input value is detected. The input value type is dependent upon the gauge type. As examples, the input value type for a tachometer is revolutions per minute (RPM), and the input value type for a speedometer is a vehicle speed. In process step 958, optionally, an input gradient value is determined. In particular, it may be determined if the change (first derivative) in the input value is positive or negative. If the gradient is positive, then a first gauge needle illumination color may be used. If the gradient is negative, then a second gauge needle illumination color may be used. This can quickly convey trend information to a user in a graphical manner, which can enhance the user experience for the operator of a vehicle. In process step 960, the corresponding gauge needle color is set, utilizing a multicolored light element (208 of FIG. 2) or other suitable mechanism, according to the rules as established (e.g. in FIG. 6 and FIG. 7). Thus, embodiments include obtaining a plurality of vehicle parameters; obtaining user settings, wherein the user settings comprise a plurality of colors and corresponding input value ranges; loading the vehicle parameters into the gauge; and loading the user settings into the gauge.

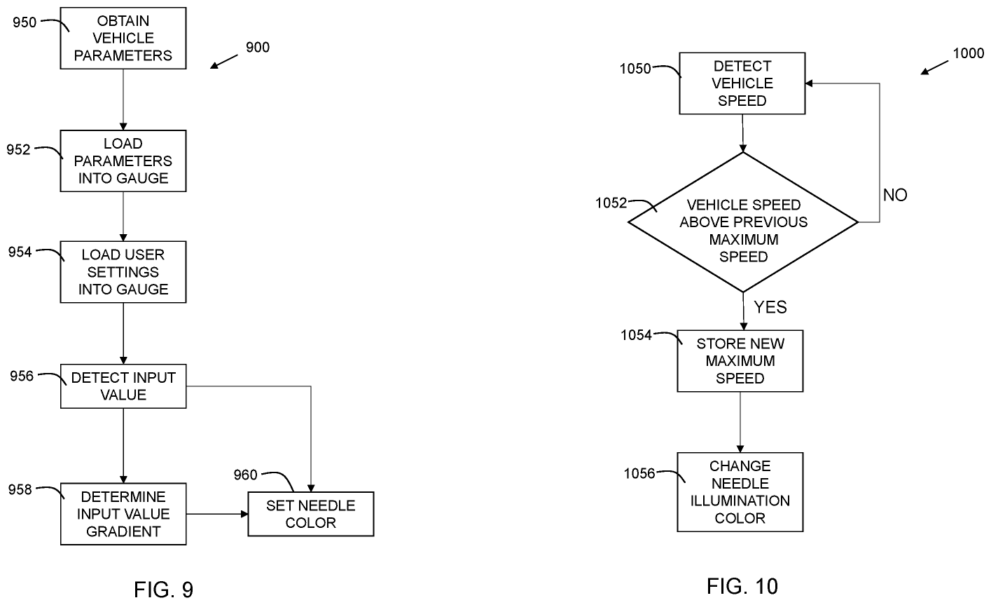

FIG. 10 is a flowchart 1000 indicating process steps for additional embodiments of the present invention. In process step 1050, a current vehicle speed is detected. In process step 1052 the current vehicle speed (input value) is compared with a previously stored maximum speed value. If the current speed value is not above the previous maximum speed, then the process returns to process step 1050. If the current speed value exceeds the previous maximum speed value, then at process step 1054, the current speed value is stored in non-volatile memory as a new maximum speed value. The process then continues to process step 1056 to change the needle illumination color. This embodiment can include a speedometer which stores a maximum speed value. When the user exceeds this value (e.g. setting a new personal speed record for the vehicle), the needle illumination color can change to a new color to indicate that there is a new maximum speed value that has been attained. Thus, embodiments include recording a previous maximum vehicle speed value; and changing a needle illumination color in response to a current vehicle speed value exceeding the previous maximum vehicle speed value.

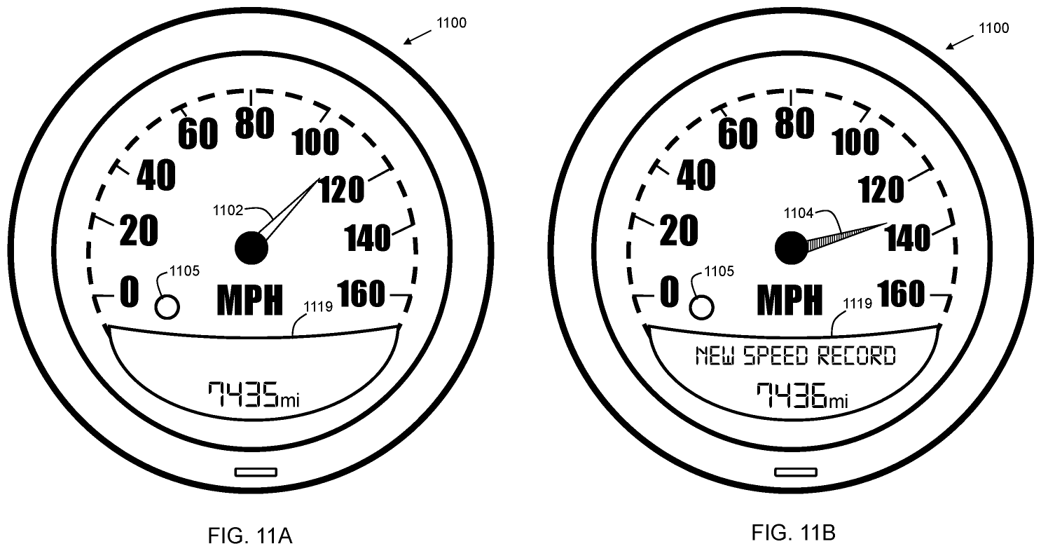

FIG. 11A shows a speedometer 1100 with an input value in a first range. Speedometer 1100 is a programmable gauge in accordance with embodiments of the present invention. Speedometer 1100 includes needle 1102 and user interface button 1105. User interface button 1105 is coupled to the processor (102 of FIG. 1) of the gauge via I/O interface 120, such that pressing the button 1105 can cause some action within the speedometer 1100. As an example, the programmable gauge may be configured such that when the user presses and holds the button 1105 for three seconds, it resets the maximum speed value to zero. Speedometer 1100 may further include a display 1119 which may include an odometer, and/or additional alphanumeric display and/or symbols to convey additional information. FIG. 11B shows the speedometer 1100 after exceeding the previous maximum speed. As an example, in a case where the previous maximum speed is 120 mph, FIG. 11A shows rendering of the needle 1102 in white, as the current speed indicated in FIG. 11A is below 120 mph. FIG. 11B shows a speedometer with an input value in a second range for a predetermined duration. Continuing with the example, in FIG. 11B, the current speed as indicated by needle 1104 exceeds 120 mph, and the speed has been exceeding 120 mph for at least a predetermined duration (e.g. at least five seconds). Therefore, the needle 1104 is illuminated in a new color. Optionally, a corresponding message may be presented on display 1119. As shown in FIG. 11B, display 1109 presents a message “New Speed Record” on the display to provide additional indication that the previous maximum speed has been surpassed.

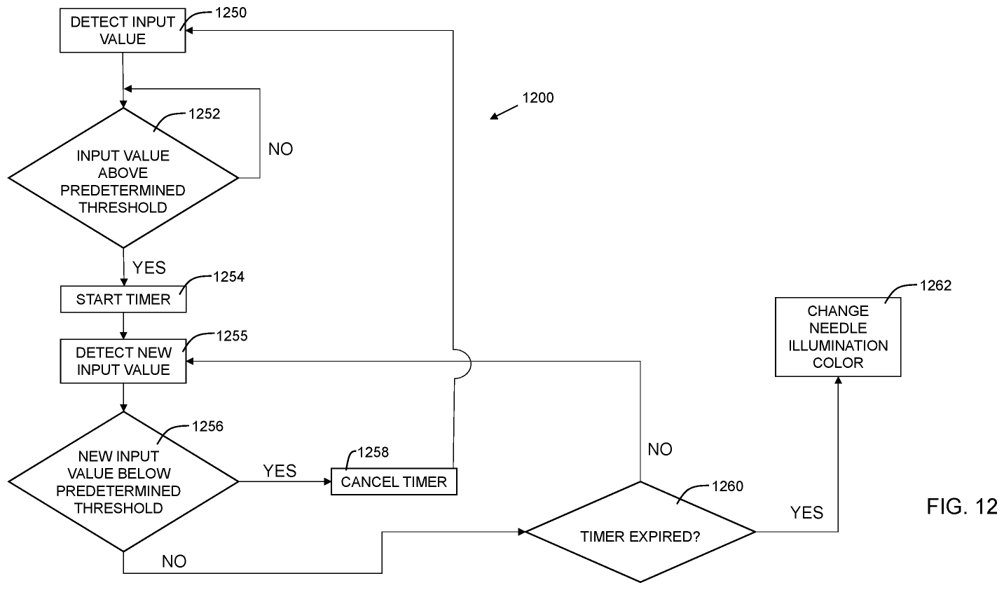

FIG. 12 is a flowchart 1200 indicating process steps for additional embodiments of the present invention. At process step 1250, an input value is detected. The input value type depends on the gauge type. For a tachometer, the input value may be in RPM (revolutions per minute). For a speedometer, the input value may be in MPH (miles per hour). At process step 1252, it is determined if the input value exceeds a predetermined threshold (e.g. 5,000 RPM for a tachometer). If not, then the process returns to process step 1250. If the input value exceeds the predetermined threshold, then a timer is started at process step 1254. In embodiments, the duration of the timer is set to a value ranging from one second to ten seconds. At process step 1255 a new input value is detected. At process step 1256, a check is made to determine if the new input value is below the predetermined threshold. If yes, then the timer is canceled at process step 1258, and the process then returns to process step 1250. If the new value is not below the predetermined threshold, then a check is made at process step 1260 to determine if the timer has expired. If not, then the process returns to process step 1255 to continue detecting new input values. If, at process step 1260, the timer has expired, the needle illumination color is changed at process step 1262. An example use case of such an embodiment is a rule for a tachometer in which when a level of 5,000 RPM is exceeded for more than five seconds, the needle illumination color changes from white to red. If the RPM briefly exceed 5,000 RPM for just two seconds, the needle illumination color does not change, and remains white.

Embodiments include obtaining a predetermined duration, wherein the gauge is configured and disposed to change a needle illumination color in response to receiving a plurality of input values in the warning range over a time period exceeding the predetermined duration. Furthermore. embodiments include changing a needle illumination color in response to the received input value exceeding a predetermined threshold for a predetermined duration. In embodiments, the memory of the programmable gauge contains instructions, that when executed by the processor, set the predetermined duration at a value ranging from two seconds to ten seconds. Other values for the predetermined duration can be used in embodiments of the present invention.

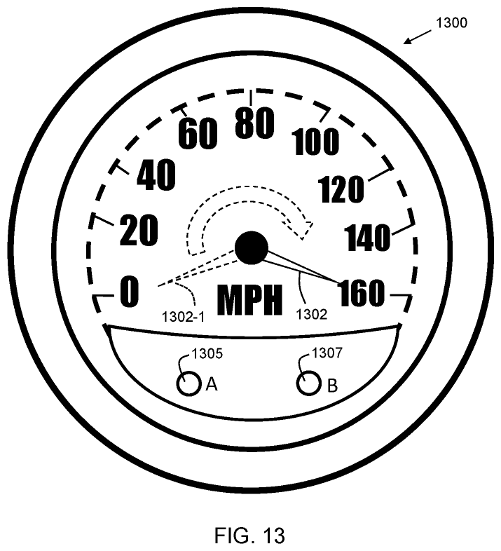

FIG. 13 shows an alternative embodiment of a programmable gauge 1300 in accordance with embodiments of the present invention. Gauge 1300 may include user interface button 1305 and user interface button 1307. As shown in FIG. 13, user interface button 1305 is marked as an “A” button, and user interface button 1307 is marked as a “B” button. In some embodiments, programmable gauge 1300 may utilize the user interface button 1305 and user interface button 1307 to configure the set points where the illumination color of gauge needle 1302 is set.

In embodiments, to program gauge 1300, the user first sets his/her vehicle to the “on” or “accessory” mode, but does not start the engine. This provides power to gauge 1300 to allow in-vehicle programming using the user interface buttons 1305 and 1307. At this time, the gauge needle is at the minimum value location position indicated by reference 1302-1. As shown, programmable gauge 1300 is a speedometer, and thus, the needle is currently pointing to zero. Disclosed embodiments can include tachometers and/or other gauges as well, that are programmed using the two user interface buttons.

Once the vehicle is in on/accessory mode, the user presses the B button (1307) to cycle through the available colors. The needle 1302 changes each time the B button is pressed, until the cycle repeats. As an example, if there are four colors (white, red, blue, yellow), pressing the B button advances to the next color, and then repeats the color sequence once the last color is reached. Once the user selects the initial color (e.g. blue) with the B button, the needle illumination color is set to the initial color (blue in this example). The user then presses the A button (1305). This starts a needle sweep, and the needle 1302 slowly moves towards its maximum value location (indicated by reference 1302). In some embodiments, the duration of the sweep may range from ten seconds to twenty seconds. As the needle slowly proceeds from the minimum value location to the maximum value location, the user presses the B button as needed to select the next color. Supposing the next color the user desires is white, then the user presses the B button twice. The first press changes the color from blue to yellow. The second press changes the color from yellow to white. In this example, the user desires the needle illumination color to change from blue to white at 60 mph. As the needle sweep continues, the needle reaches the position where it is pointing at the 60-mph indication location on gauge 1300. The user then presses the A button to mark 60 mph as a set point for the white color. In embodiments, the needle may blink one or more times to provide a confirmation of the setting to the user. The user then presses the B button again to change the needle illumination color from white to red. When the needle reaches the 100-mph indication location, the user presses the A button again to mark 100 mph as a set point for the red color. The aforementioned scenario is exemplary, and the user can set additional set points for other colors if desired. When the needle reaches the maximum value location (160 mph in this case, as indicated by reference 1302), the needle sweep ends, and the set points programmed by the user, and corresponding needle illumination colors, are stored in non-volatile storage (e.g. 106 of FIG. 1).

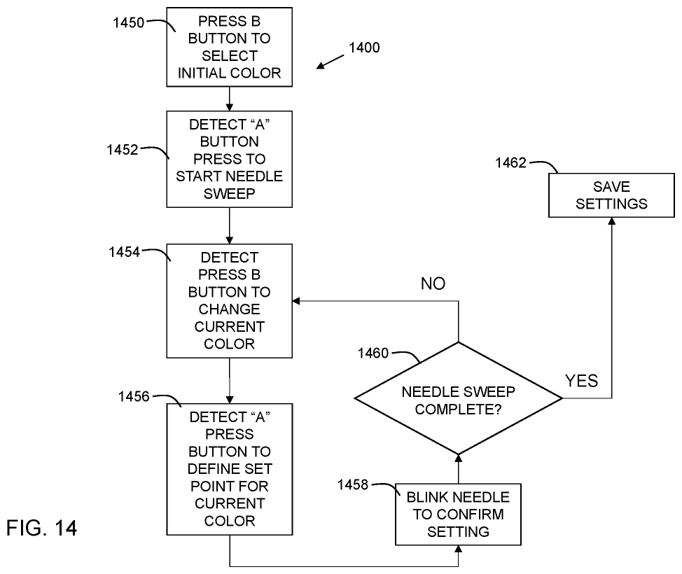

FIG. 14 is a flowchart 1400 indicating process steps for configuring the programmable gauge of FIG. 13. In process step 1450, the B button is pressed as many times as needed to select a desired initial needle illumination color. In process step 1452, the A button is pressed to start the needle sweep. In process step 1454, as the needle is slowly sweeping across the gauge from the minimum value location to the maximum value location, the user can press the B button again to select a new needle illumination color. When the needle reaches the desired indication location, the user presses the A button at process step 1456 to indicate a set point for the current needle illumination color. Optionally, the needle may blink at process step 1458 to provide confirmation to the user of the establishment of the set point. At 1460, a check is made to determine if the needle sweep is complete. If not, then the process continues back to process step 1454 to detect user interface button presses. If yes, then the settings are saved in the non-volatile storage of the gauge at process step 1462.

As can now be appreciated, disclosed embodiments enable a new level of interactive customization of gauges for a variety of applications. By changing the needle illumination color based on an input value for that gauge, a gauge needle color can be used to convey meaningful information regarding the operation of a vehicle. Additionally, allowing a user to select a needle color provides additional customization options for the user, allowing him/her to give a unique appearance of a vehicle interior.

Although the invention has been shown and described with respect to a certain preferred embodiment or embodiments, certain equivalent alterations and modifications will occur to others skilled in the art upon the reading and understanding of this specification and the annexed drawings. In particular regard to the various functions performed by the above described components (assemblies, devices, circuits, etc.) the terms (including a reference to a “means”) used to describe such components are intended to correspond, unless otherwise indicated, to any component which performs the specified function of the described component (i.e., that is functionally equivalent), even though not structurally equivalent to the disclosed structure which performs the function in the herein illustrated exemplary embodiments of the invention. In addition, while a particular feature of the invention may have been disclosed with respect to only one of several embodiments, such feature may be combined with one or more features of the other embodiments as may be desired and advantageous for any given or particular application.

What is claimed is:

1. A programmable gauge, comprising
a processor;
a memory coupled to the processor;
a needle;
a needle motion controller;
a multicolored light element configured and disposed to illuminate the needle;
wherein the memory contains instructions, that when executed by the processor, cause the gauge to receive an input value, and configure the needle motion controller and multicolored light element in response to the received input value.

2. The gauge of claim 1, wherein the memory further contains instructions, that when executed by the processor, receive a first range corresponding to a first needle illumination color, and a second range corresponding to a second needle illumination color.

3. The gauge of claim 2, wherein the memory further contains instructions, that when executed by the processor, receive a third range corresponding to a third needle illumination color.

4. The gauge of claim 2, wherein the programmable gauge is a tachometer, and the input value is an engine speed value.

5. The gauge of claim 1, wherein the memory further contains instructions, that when executed by the processor, receive a first ascending range and a first descending range corresponding to a first needle illumination color, and a second ascending range and a second descending range corresponding to a second needle illumination color.

6. The gauge of claim 2, wherein the memory further contains instructions, that when executed by the processor, configure the programmable gauge as a fuel gauge, and the input value is a fuel level value.

7. The gauge of claim 2, wherein the memory further contains instructions, that when executed by the processor, configure the programmable gauge as a speedometer, and the input value is a vehicle speed value.

8. The gauge of claim 1, wherein the multicolored light element comprises a multicolor light-emitting diode.

9. The gauge of claim 1, wherein the memory contains instructions, that when executed by the processor, perform the steps of:
recording a previous maximum vehicle speed value; and
changing a needle illumination color in response to a current vehicle speed value exceeding the previous maximum vehicle speed value.

10. The gauge of claim 1, wherein the memory contains instructions, that when executed by the processor, perform the step of changing a needle illumination color in response to the received input value exceeding a predetermined threshold for a predetermined duration.

11. The gauge of claim 10, wherein the memory contains instructions, that when executed by the processor, set the predetermined duration at a value ranging from two seconds to ten seconds.

12. The gauge of claim 1, further comprising a wireless communication interface.

13. The gauge of claim 12, wherein the wireless communication interface includes a Bluetooth interface.

14. A computer-implemented method for programming a gauge, comprising:
obtaining a plurality of vehicle parameters;
obtaining user settings, wherein the user settings comprise a plurality of colors and corresponding input value ranges
loading the plurality of vehicle parameters into the gauge; and
loading the user settings into the gauge.

15. The method of claim 14, wherein obtaining user settings comprises obtaining a normal range, a caution range, and a warning range.

16. The method of claim 15, further comprising obtaining ascending limits and descending limits for at least one of the normal range, caution range, and warning range.

17. The method of claim 14, further comprising rendering a simulated gauge that includes a needle rendered with a needle illumination color.

18. The method of claim 17, wherein the simulated gauge is a tachometer.

19. The method of claim 17, wherein the simulated gauge is a speedometer.

20. The method of claim 15, further comprising obtaining a predetermined duration, wherein the gauge is configured and disposed to change a needle illumination color in response to receiving a plurality of input values in the warning range over a time period exceeding the predetermined duration.
